(19) United States
(12) Patent Application Publication
(10) Pub. No.: US 2014/0115463 A1
(43) Pub. Date: Apr. 24, 2014

(54) SYSTEMS AND METHODS FOR COMPILING MUSIC PLAYLISTS BASED ON VARIOUS PARAMETERS

(71) Applicant: DAISY, LLC, (US)

(72) Inventors: Trent Reznor, Beverly Hills, CA (US); Rob Sheridan, Los Angeles, CA (US); Fredric Vinna, Stockholm (SE); Brian Frank, Sherman Oaks, CA (US)

(73) Assignee: DAISY, LLC, Santa Monica, CA (US)

(21) Appl. No.: 13/657,742

(22) Filed: Oct. 22, 2012

(51) Int. Cl. G06F 3/01

(52) U.S. Cl. 715/716

(57) ABSTRACT

Systems and methods are provided for generating playlists within a music service executing on an electronic device. According to certain aspects, the systems and methods identify various parameters based on a setting or condition of the electronic device. The systems and methods determine one or more songs based on the various parameters and add the one or more songs to a playlist that is displayed on an interface of the electronic device. According to embodiments, the systems and methods enable the user to initiate playback of the playlist via the interface.

### FIELD

This application generally relates to systems and methods for implementing and managing a music service. In particular, the application relates to platforms and techniques for determining music based on various conditions and parameters, and presenting the music to the user as a playlist.

### BACKGROUND

Music services are gaining in popularity as more consumers seek immediate access to comprehensive music libraries. For example, instead of purchasing individual copies of songs or albums (e.g., CDs), consumers can register with various music services to access music offered by the music services. Particularly, various music services and platforms enable users to download or stream specific songs, albums, or playlists to desktop applications or mobile devices. However, there are deficiencies in existing music services and platforms.

In particular, the existing music services and platforms do not enable users to efficiently or effectively discover and organize new music and/or music that could be of potential interest to the users. Particularly, if a user wants to build or otherwise access a playlist, the user must manually add all of the songs to the playlist or otherwise access a playlist that is pre-constructed by another user. Further, although some music services stream music to a user that is similar to music selected by the user, such as via a radio feature, these music services do not select music according to various settings or situations of the user and/or an electronic device of the user.

Accordingly, with the advent and popularity of music services offering users the ability to expand their access to music libraries, there is an opportunity for systems and methods for generating playlists based on various settings and conditions associated with a user and/or the user's electronic device. Particularly, there is an opportunity for systems and methods for generating the playlists and enabling the user to initiate a playback of the playlists responsive to an initiation of a music service application.

### SUMMARY OF THE INVENTION

The application is defined by the appended claims. This description summarizes aspects of the embodiments and should not be used to limit the claims.

The application is intended to solve the above-noted business and technical problems by providing systems and methods for generating playlists for users. In one embodiment, a method for generating playlists for a user of an electronic device is provided. The method initiates a music application of the electronic device and, responsive to the initiating, identifies at least one parameter related to a setting or an environment of the electronic device. The method further determines, by a processor, at least one song based on the at least one parameter, adds the at least one song to a playlist, and displays, on an interface associated with the music application, an indication of the playlist, wherein the indication of the playlist enables the user to initiate playback of the playlist.

In another embodiment, an electronic device capable of generating playlists for a user is provided. The electronic device comprises an interface capable of receiving inputs from the user and presenting information to the user, and a processor coupled to the user interface. The processor is configured to initiate a music application and, responsive to the initiating, identify at least one parameter related to a setting or an environment of the electronic device. The processor further determines at least one song based on the at least one parameter, adds the at least one song to a playlist, and displays, on an interface associated with the music application, an indication of the playlist, wherein the indication of the playlist enables the user to initiate playback of the playlist.

### BRIEF DESCRIPTION OF THE DRAWINGS

For a better understanding of the invention, reference may be had to embodiments shown in the following drawings in which:

FIG. 1 is a block diagram illustrating an exemplary environment for implementing and managing a music service, in accordance with embodiments.

FIG. 2 is a diagram illustrating various functionalities associated with implementing and managing a music service, in accordance with embodiments.

FIG. 3 illustrates an exemplary interface associated with an electronic device, in accordance with embodiments.

FIG. 4 illustrates an exemplary interface associated with a music service application, in accordance with embodiments.

FIG. 5 illustrates an exemplary interface associated with a music service application, in accordance with embodiments.

FIG. 6 illustrates an exemplary interface associated with a music service application, in accordance with embodiments.

FIG. 7 is a diagram of an exemplary device configured to interface with a music service, in accordance with embodiments.

FIG. 8 is a diagram of an exemplary music service server, in accordance with embodiments.

FIG. 9 is a flow diagram depicting playlist generation techniques, in accordance with embodiments.

### DETAILED DESCRIPTION OF PREFERRED EMBODIMENTS

While the invention may be embodied in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

In accordance with one or more principles of the invention, systems and methods are provided for generating playlists within a music service or application based on parameters, conditions, settings, environments, or the like that are associated with a user, the user's electronic device, and/or surroundings of the user and/or the user's electronic device. For example, the systems and methods can identify songs for the playlist based on a time, date, weather condition, calendar appointment, current location, and/or other parameters or conditions. According to embodiments, the systems and methods can implement the music service as part of an electronic device, server computer, and/or other hardware device with various combinations of hardware and software components.

In operation, the electronic device can initiate the music service and, responsive to the initiation, can identify one or more various parameters associated with the user and/or the electronic device. In aspects, the electronic device can determine songs by comparing the parameters to various attributes of the songs and can add the songs to a playlist. The electronic device further provides, in an interface of the music service, an indication of the playlist and enables the user to initiate playback of the playlist.

As used herein, a “music service” can be understood to be any service, platform, application, or the like that enables a set of users to access and manage media data such as music, among other functionalities. In some embodiments, the set of users can register with the music service. Further, as used herein, a “playlist” can be understood to be a listing, indication, or aggregation of one or more songs, tracks, and/or other media data files accessible to and manageable by one or more users, and from which the one or more users can select one or more songs for playback. In some cases, the media data files can be accessible locally to the device from which the user is accessing the playlist. In other cases, the media data files can be accessible via streaming from a remote server or from other devices connected to the device via a network.

It should be understood that any music identifying, determining, locating, retrieving, providing or the like can be facilitated by an electronic device singularly, or by the electronic device in communication with a server, such as a music service server. For example, the electronic device (e.g., smartphone, tablet computer, notebook computer, etc.) can request a server to locate one or more songs based on various parameters communicated from the electronic device to the server. Further, the server can provide any located songs to the electronic device for playlist generation functionalities and/or for playback by a user. Further, both the electronic device and the server can execute a music service or similar music service module to implement the functionalities as discussed herein.

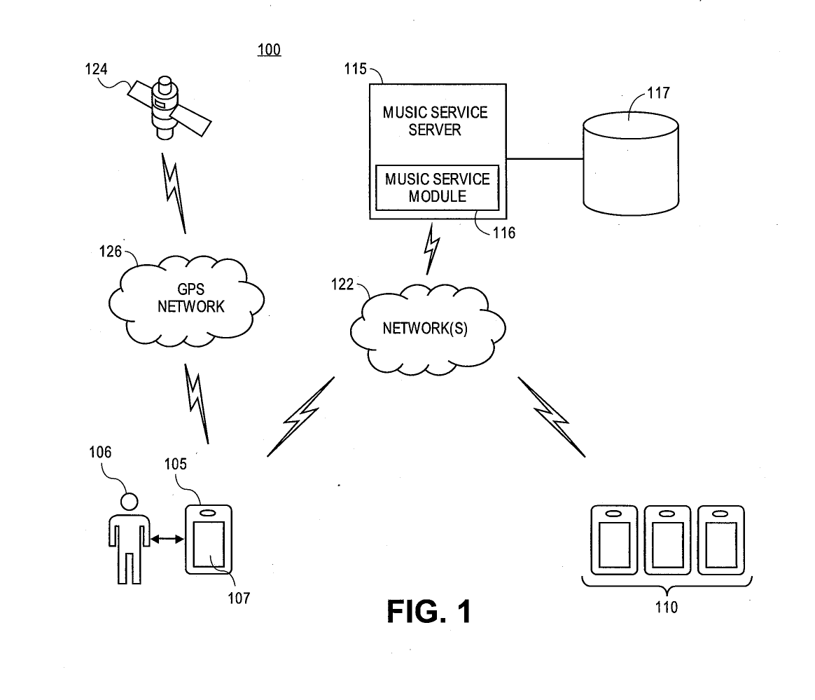

FIG. 1 depicts an environment 100 comprising components and entities of the embodiments as discussed herein. It should be appreciated that the environment 100 is merely exemplary and can comprise fewer or more components and entities, as well as other various combinations of components and entities.

As shown in FIG. 1, the environment 100 comprises a device 105 configured to communicate with a music service server 115. In embodiments, it should be understood that the device 105 can be any type of device such as, for example, a smart phone, a notebook or desktop computer, a tablet device, a personal data assistant (PDA), or the like, comprising any type of hardware or software components, or combinations thereof. The device 105 can execute a music service application 107 configured to facilitate the functionalities as discussed herein. As shown in FIG. 1, a user 106 can interface with the device 105 and/or the music service application 107 thereof to interface with and manage various functionalities associated with the components of the environment 100. The music service server 115 can comprise a combination of hardware or software components (such as a music service module 116), or combinations thereof, configured to support the facilitation of a music service and the playlist generation techniques as described herein. In some embodiments, the user 106 of the device 105 can register for an account or a registration with an associated music service and the music service server 115 and components thereof can provide music data to the device 105 in accordance with a subscription of the user 106. For example, in some cases, the user 106 can select to download songs, tracks, and/or other media data files from the music service server 115 to the device 105. In other cases, the music service server 115 can stream songs, tracks, playlist files including songs, and/or other media data files to the device 105 for access and consumption by the user 106.

In embodiments as shown, the music service server 115 can couple to storage 117 that can be configured to store data associated with the music service server 115. For example, the storage 117 can store any associated music data as well as data related to subscriptions and other account information for users of the music service server 115. The device 105 can connect to the music service server 115 via a network 122 such as, for example, a wide area network (WAN), a local area network (LAN), or other networks. The network 122 can facilitate any type of wireless data communication via any standard or technology (e.g., GSM, CDMA, TDMA, WCDMA, EDGE, OFDM, GPRS, EV-DO, WiMAX, WiFi, Bluetooth, UWB, and others). More particularly, the device 105 can send data to and receive data from the music service server 115 via the network 122. For example, the music service server 115 can receive parameters from the device 105 and can transmit or stream music data to the device 105 according to the parameters.

As shown in FIG. 1, the environment 100 can further comprise a set of additional devices 110 that can also be configured to connect to the music service server 115 via the network 122. Each of the set of additional devices 110 can be associated with a set of additional users of the music service implemented by the music service server 115. More particularly, each of the set of additional users can have an associated account with the music service or can otherwise register with the music service. In embodiments, the device 105 can be configured to connect to and/or exchange data with the set of additional devices 110 via the network 122. Any of the additional devices 110 can send song data to the device 105 via the network 122.

As shown in FIG. 1, the environment 100 can further comprise a satellite 124 such as a global positioning system (GPS) satellite that can be configured to provide GPS information to the device 105 via a GPS network 126. In particular, the device 105 can be configured with a GPS receiver chip that can calculate GPS coordinates to locate the device 105, determine a venue or specific location in which the device 105 is located, and perform other functionalities.

According to implementations, the music service server 115, the device 105, and the set of additional devices 110, and components thereof, can facilitate the management of music subscriptions of the users of the respective devices 105, 110. More particularly, the music service server 115 (and the music service module 116 thereof), the device 105 (and the music service application 107 thereof), and/or the set of additional devices 110 can generate playlists and provide songs of the playlists to the users of the device 105 and/or the set of additional devices 110. Particularly, users of the device 105 and/or the set of additional devices 110 can interface with respective devices 105, 110 to initiate a music service or application and control the functionalities of the music service. The device 105 and/or the set of additional devices 110 can communicate with the music service server 115 to identify songs based on the various playlist generation parameters, and the device 105 and/or the set of additional devices 110 can provide indications of the identified songs to the users. In some embodiments, the user can select to play a playlist, at which point the music service server 115 can retrieve the appropriate songs from the storage 117 and provide (e.g., by streaming) the songs to the appropriate device 105, 110. In some embodiments, one or more of the songs can be played from a local cache of the appropriate device 105, 110. In further embodiments, one or more of the songs can be retrieved via a peer-to-peer (P2P) network among the device 105 and the set of additional devices 110.

According to embodiments, each of the songs associated with the music service can have one or more attributes. For example, the attributes can encompass structures, compositions, rhythms, meters, roots, tonalities, instrumentations, leanings or stylings, recording techniques, influences, types of instrumental ensembles, types of individual instruments, lyrical content, vocal presences, and/or other elements. The music service can identify the attributes of the songs and associate the attributes with the songs. Further, the music service can determine which songs are similar to one another, and to what degree or extent. For example, the music service can determine, based on one or more of the attributes, that songs by a certain artist or band are similar to songs by another artist or band. In some embodiments, the music service can maintain similarity degrees or levels among songs whereby, for example, Song A is more similar to Song B than Song A is to Song C. Further, in embodiments, the music service can update similarity and attribute information based on user ratings, listening behaviors (e.g., songs skipped, listening times, etc.), and/or other factors. In some embodiments, the attributes can be assigned to songs manually by one or more users or administrators. Collectively, these described functions and benefits can be implemented within a music service facilitated by and accessible to the components of the environment 100. It should be appreciated that other similarity determination functionalities, algorithms, or techniques are envisioned.

According to embodiments, each user of the music service can have an associated music profile that can include any data related to the musical tastes, preferences, listening history, interactions or social network connections with artists and/or other users, listening trends, songs or artists that share similarities with other songs or artists that the user enjoys, has listened to, and/or is otherwise associated with the user, and/or any other data that can indicate the songs, bands, artists, genres, and/or musical eras that a user tends to enjoy or not enjoy. In embodiments, the music profile of the user can be based on other users, entities, or music or playlist curators that the user “follows,” subscribes to, or is otherwise associated with in the music service.

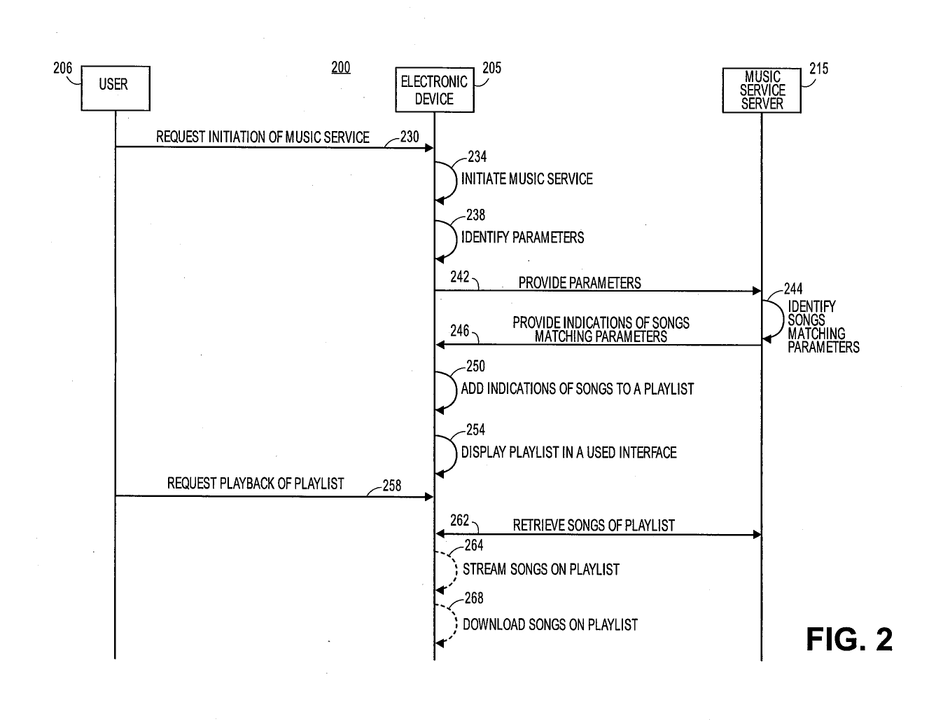

A diagram 200 illustrating the present embodiments is depicted in FIG. 2. As shown, the diagram 200 includes a user 206 (such as the user 106 as discussed with respect to FIG. 1), an electronic device 205 (such as the electronic device 105 as discussed with respect to FIG. 1), and a music service server 215 (such as the music service server 115 as discussed with respect to FIG. 1).

According to embodiments, the user 206 can request (230) an initiation of the music service or application. In some cases, the user can select an icon corresponding to the music service on an interface of the electronic device 205. The electronic device 205 can initiate (234) the music service and, responsive to the initiation, can identify (238) one or more parameters associated with a setting, a condition, an environment, or the like of the user 206 and/or the electronic device 205. For example, the parameters can be one or more of the date, the time, a day of the week, the current or forecasted weather (e.g., temperature, precipitation conditions, etc.), and/or other similar parameters. For further example, the parameters can be a location of the electronic device 205, such as a GPS location or a venue associated with the location of the electronic device 205. In embodiments, the electronic device 205 can determine its location via its GPS coordinates. In further embodiments, the user 206 can interface with the electronic device 205 to “check in” to a specific location or venue, such as a gym, restaurant, store, and/or the like.

According to some embodiments, the electronic device 205 can identify the parameters via interfacing with applications of the electronic device 205. In some cases, the electronic device 205 can examine a calendar application to identify a holiday (e.g, July 4th, Christmas, etc.), or one or more scheduled appointments, meetings, or the like. For example, the electronic device 205 can identify a current, upcoming, or scheduled party, trip, and/or other type of event or occurrence. In other cases, the electronic device 205 can interface with a social networking application to determine one or more connections of the user 206, other users with whom the user 206 is with (such as if the users are with the user 206 at a party), and/or associated music profiles of any of such users. In embodiments, the parameters can also be based on a music profile of the user 206 or other users. It should be appreciated that other application interfacing and parameter determination techniques, as well as parameter types, are envisioned. Further, it should be appreciated that the parameters can be based on any setting, condition, environment, or the like associated with the user 206, the electronic device 205, and/or surroundings of the user 206 and/or the electronic device 205.

As an example, the electronic device 205 can determine that the current date is December 31 (i.e., New Year's Eve), and can further interface with a calendar application of the electronic device 205 to determine that the user is hosting a party at the user's house (i.e., can determine that the current time is 8:00 PM and that the party is scheduled to start at 8:00 PM). Further, the electronic device 205 can determine other users who will be attending the party (e.g., by interfacing with the calendar or other scheduling application, by interfacing with a social networking application, or by other techniques) and can identify music profiles of the other users.

As shown in FIG. 2, the electronic device 205 can provide (242) the parameters to the music service server 215. Particularly, the electronic device 205 can send the parameters to the music service server 215 via a network connection. Upon receipt of the parameters, the music service server 215 can identify (244) one or more songs that match the parameters. Particularly, the music service server 215 can match the parameters to various attributes associated with the songs. For example, if the parameters indicate that the user is at the gym (or that the user is hosting a party on New Year's Eve), the music service server 215 can identify songs that are upbeat and/or that are similar to songs that the user has previously listened to while at the gym (e.g., by examining the user's music profile). For further example, if the parameters indicate that it is Monday morning, then the music service server 215 can identify mellow songs, perhaps because the user 206 may be on his or her way to work. In embodiments, the music service server 215 can identify songs based on a music profile of the user 206 in addition to the parameters. In certain embodiments, the electronic device 205 itself can identify the songs based on the parameters.

The music service server 215 can provide (246) indications of the songs matching the parameters to the electronic device 205. In embodiments, the indications can include metadata identifying the artist, song, album, album artwork, and/or other data. In some cases, the music service server 215 can send or transmit the songs themselves to the electronic device 205. The electronic device 205 can add (250) indications of the songs to a playlist and display (254) or present the playlist in a user interface of the electronic device. In embodiments, the playlist can indicate the metadata associated with one or more of the songs (e.g., artist, song title, album, album artwork, etc.). Further, in embodiments, the displayed playlist can include a selectable option to initiate playback of the playlist.

The user 206 can request (258) playback of the playlist. In some cases, the user can select the selectable option displayed on the user interface to request playback of the playlist. In response to the user 206 requesting the playback, the electronic device 205 can retrieve (262) the songs of the playlist from the music service server 215. In some cases, the electronic device 205 can stream (264) the songs on the playlist during the playback of the playlist. In other cases, the electronic device 205 can download (268) the songs for storage in local storage of the electronic device 205 and for access during the playback of the playlist.

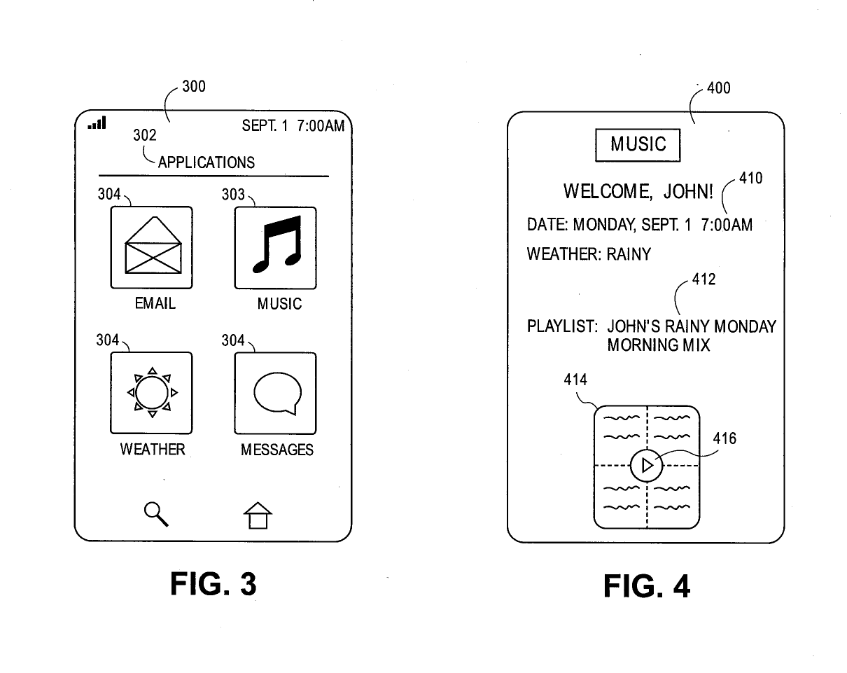

FIGS. 3-6 illustrate exemplary interfaces associated with the execution, facilitation, and implementation of the music service. More particularly, FIG. 3 illustrates an exemplary interface associated with initiating a music service application and FIGS. 4-6 illustrate exemplary interfaces associated with the music service application. The exemplary interfaces can be displayed on a device of the user, such as the device 105. The device can be configured to execute the music service application, and the interfaces of the music service application enable the user to provide input associated with various functionalities. The data associated with the exemplary interfaces can be transmitted to, received from, and/or synchronized with a server, such as the music service server 115. The user can interface with the music service application via a user interface of the device, such as a touchscreen. It should be appreciated that the interfaces of FIGS. 3-6 are merely exemplary and can comprise other various details and/or elements.

Referring to FIG. 3, depicted is an exemplary screenshot of an interface 300 associated with the operation of a device, such as functionalities associated with an operating system. Particularly, the interface 300 enables a user of the device to initiate an application associated with the music service. As shown in FIG. 3, the interface 300 includes an application section 302 that lists various applications that are installed on the device. It should be appreciated that the application section 302 is merely exemplary and can include other applications and/or combinations of applications.

As shown in FIG. 3, the application section 302 includes icons 304 associated with applications installed on the device. For example as shown, the icons 304 are associated with an email application, a messages application, and a weather application. Additionally, the application 302 section includes a music application icon 303 that is associated with the music service application as described herein. In operation, the user can select the music application icon 303 via an interaction (e.g., a touchscreen selection) with the interface 300. In response to the device detecting the interaction, the device can initiate the music service application.

Referring to FIGS. 4-6, depicted are exemplary screenshots of interfaces 400, 500, 600 associated with the operation of the music service application. In some cases, the music service application can display the interfaces 400, 500, 600 as a home screen, initial screen, welcome screen, or the like of the music service. More particularly, the music service application can display the interfaces 400, 500, 600 upon initiating the music service application. In other cases, the music service application can display the interfaces 400, 500, 600 at other points or after certain user navigation through the music service application. According to embodiments, the interfaces 400, 500, 600 include parameter indicators 410, 510, 610 that detail various parameters related to a setting or condition of the electronic device or a user of the electronic device. Upon the device initiating the music service application, the music service can determine the various parameters as shown in the parameter indicators 410, 510, 610.

Responsive to determining the parameters, the music service application can determine or identify at least one song based on the parameters. According to one embodiment, the device can send the parameters to a music service server configured to identify the songs based on matching the parameters to attributes of the songs, as discussed herein. In another embodiment, the music service application can identify songs local to the device based on matching the parameters to attributes of the local songs. According to embodiments, the music service application can add the identified songs to a playlist or otherwise compile the songs in a listing. In some embodiments, the music service application can identify the songs based on a music profile of the user.

The music service application can generate playlist titles 412, 512, 612 to describe or otherwise identify the playlists. In embodiments, the playlist titles 412, 512, 612 can be based on the identified parameters of the device. It should be appreciated that the music service application can generate the playlist titles 412, 512, 612 according to any algorithm or technique. As shown in FIGS. 4-6, the music service application can display indications 414, 514, 614 of the playlist that can include various metadata associated with one or more songs of the playlist. For example, the indications 414, 514, 614 can include album artwork, song titles, album titles, artists names, and/or other data or information.

Further, in embodiments, the music service application can display selectable options 416, 516, 616 that enable a user to initiate a playback of the playlist. As shown, the selectable options 416, 516, 616 are graphics of a play button, although other or additional selectable options 416, 516, 616 are envisioned. For example, the selectable options 416, 516, 616 can include other playback functions such as skipping a track, replaying a track, pausing playback, volume control, and/or other functions. In operation, the music service application can detect a selection, by a user, of any of the selectable options 416, 516, 616 and, in response to detecting the selection, can initiate playback of the associated playlist and/or any corresponding functions relating to the playback of the associated playlist.

Referring to FIG. 4, the identified parameters can be the time, date, and weather associated with a location of the device. For example, if the device is located in Los Angeles, Calif., then the music service can determine the current time, date, and weather in Los Angeles, Calif. In embodiments as shown, the parameter indicator 410 indicates a date of Monday, September 1, a time of 7:00 AM, and a rainy weather condition. Further, the playlist title 412 can be related to the identified parameters (as shown: “JOHN'S RAINY MONDAY MORNING MIX”). According to embodiments, the indication 414 of the generated playlist can include songs that are based on the parameters (here: rainy weather, Monday morning, etc.). Particularly, the songs of the generated playlist can be mellow, have a slower beat, or can otherwise have attributes that are based on these parameters and/or a music profile of the user.

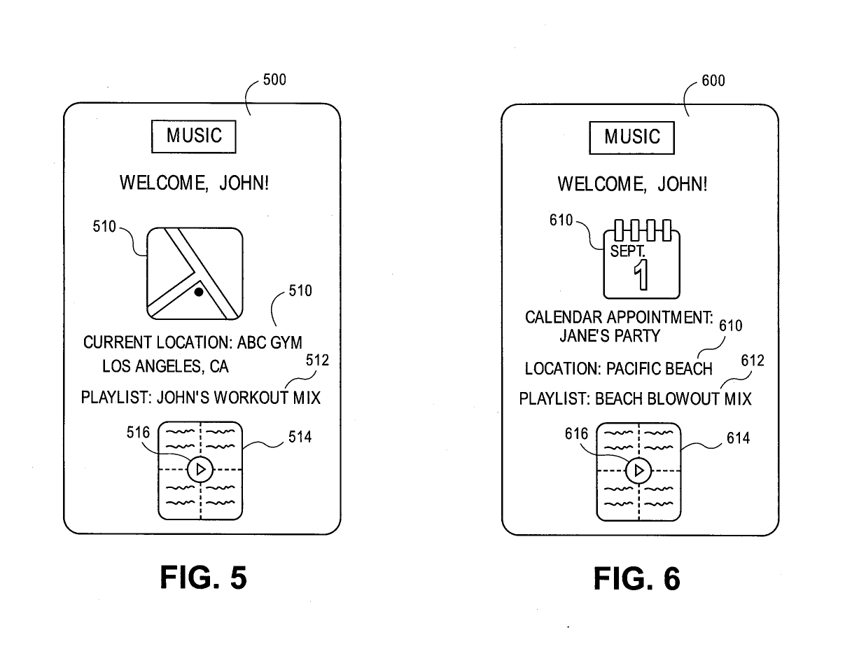

Referring to FIG. 5, the identified parameters can be a location of the device and/or a user of the device. As shown, the music service can determine that the device is located (e.g., via a GPS calculation) at a location as depicted in the map of the parameter indicator 510. Additionally, the parameter indicator 510 can determine a specific venue in which the device is located (as shown: ABC GYM). In embodiments, the user can manually select the specific venue from a list that can be populated with venues or locations near an identified location of the device. Further, the playlist title 512 can be related to the identified parameters (as shown: “JOHN'S WORKOUT MIX”). According to embodiments, the indication 514 of the generated playlist can include songs that are based on the parameters (here: gym location). Particularly, the songs of the generated playlist can be upbeat or can otherwise have attributes that are based on these parameters and/or a music profile of the user.

Referring to FIG. 6, the identified parameters can be an appointment associated with a calendar application of the device. Particularly, the music service can interface with the calendar application to determine a concurrent or upcoming appointment or item scheduled by the user. As shown, the music service can determine that, on September 1, the user has a scheduled appointment for “Jane's Party” at Pacific Beach, as indicated by the parameter indicator 610. In embodiments, the user can manually select or input a specific appointment or scheduled item. Further, the playlist title 612 can be related to the identified parameters (as shown: “BEACH BLOWOUT MIX”). According to embodiments, the indication 614 of the generated playlist can include songs that are based on the parameters (here: a beach party). Particularly, the songs of the generated playlist can be upbeat or can otherwise have attributes that are based on these parameters and/or a music profile of the user.

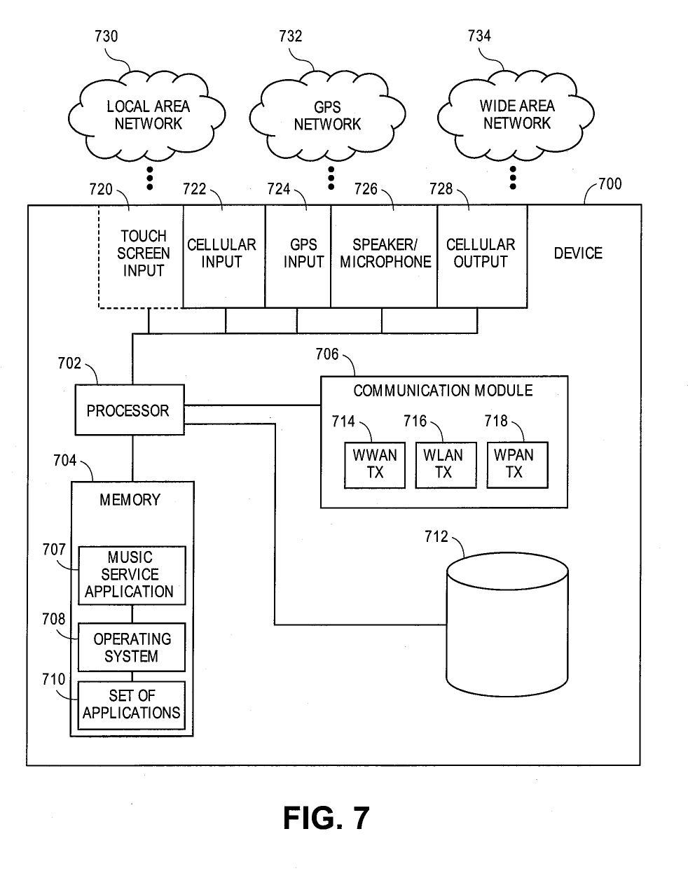

Referring to FIG. 7, depicted is an exemplary device 700 and components thereof. More particularly, a user can use the device 700 to access the music service to facilitate any functionalities as described herein. It should be appreciated that FIG. 7 represents a generalized schematic illustration and that other components can be added or existing components can be removed or modified.

As shown in FIG. 7, the device 700 can comprise a set of ports that can receive input signals or data from, or output signals or data to, other components of a media distribution environment, such as the environment 100 as discussed with respect to FIG. 1. More particularly, a cellular input port 722 can receive cellular data from a wide area network 734 (such as various private or public networks), a GPS input port 724 can receive GPS coordinate data from a GPS network 734, and a cellular output port 728 can output data to the wide area network 734. The device 700 can further comprise an optional touchscreen input port 720 that can receive inputs from interactions with a touchscreen by a user operating the device 700.

The device 700 can further comprise a processor 702 communicating with a memory 704, such as electronic random access memory (RAM), or other forms of transitory or non-transitory computer readable storage mediums, operating under control of or in conjunction with an operating system 708. The operating system 708 can be any commercial, open-source, or proprietary operating system or platform. The processor 702 can communicate with a database 712, such as a database stored on a local hard drive. While illustrated as a local database in the device 700, the database 712 can be separate from the device 700.

The processor 702 can further communicate with a communication module 706, such as a wired or wireless data connection, which in turn communicates with the wide area network 734. Further, the communication module 706 can comprise radio transceivers that communicate with a wireless local area network 730 or other networks, such as various personal area networks. The communication module 706 can comprise a WWAN transceiver 714 capable of communicating with the wide area network 734, a WLAN transceiver 716 capable of communicating with the local area network 730, and a WPAN transceiver 718 capable of communicating with a personal area network (such as a Bluetooth® network). Although not shown in FIG. 7, the communication module 706 can further include various components for communicating with a GPS network.

The set of ports 720, 722, 724, 726 of the device 700 can use the components of the communication module 706 to connect to the entities of the environment 100. For example, the cellular input port 722 can receive streaming song data via the WWAN transceiver 714. The processor 702 can also communicate with a set of applications 710 that can be configured to execute control logic and perform data processing to perform the functions and techniques as discussed herein. For example, the set of applications 710 can comprise a music service application 707 that can provide the interfaces as described herein, receive inputs from the user, and facilitate the communication of data among the entities of the environment 100. It should be appreciated that other applications 710 and functionalities thereof are envisioned.

While FIG. 7 illustrates the device 700 as a standalone system using a combination of hardware and software, the components of the device 700 can also be implemented as a software application or program capable of being executed by a conventional computer platform. Likewise, the components of the device 700 can also be implemented as a software module or program module capable of being incorporated in other software applications and programs. In either case, the components of the device 700 can be implemented in any type of conventional proprietary or open-source computer language.

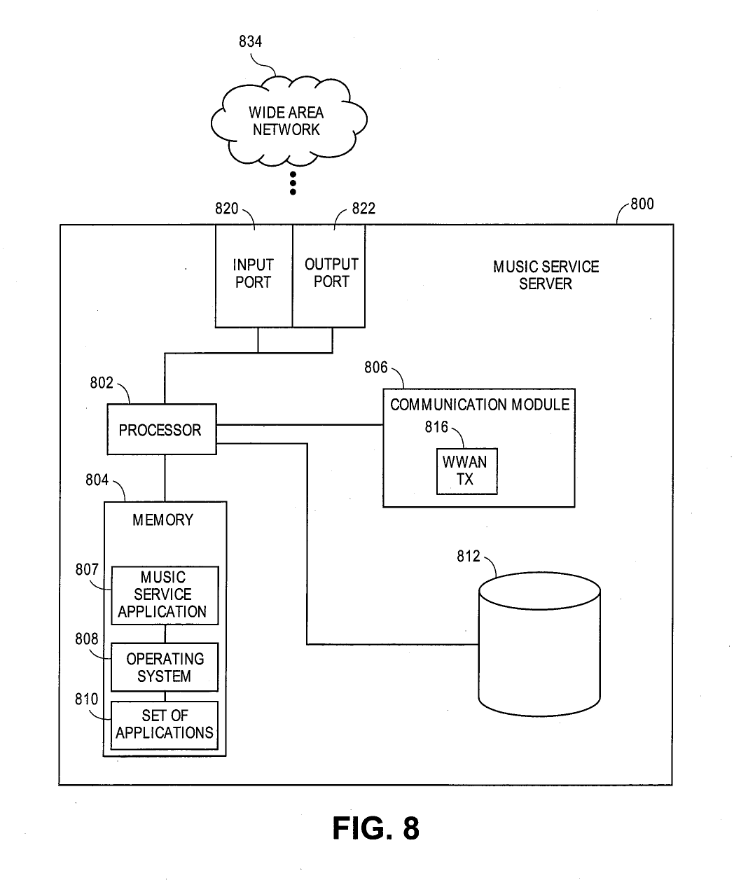

Referring to FIG. 8, depicted is an exemplary server and components thereof. More particularly, the server 800 can be the music service server 115 as discussed with respect to FIG. 1. It should be appreciated that FIG. 8 represents a generalized schematic illustration and that other components can be added or existing components can be removed or modified.

As shown in FIG. 8, the server 800 can comprise a set of ports that can receive input signals or data from, or output signals or data to, other components of a media distribution environment, such as the environment 100 as discussed with respect to FIG. 1. More particularly, an input port 820 can receive cellular or other types of data from a wide area network 834 (such as various private or public networks), and an output port 822 can output data to the wide area network 834, such as streaming music data.

The server 800 can further comprise a processor(s) 802 communicating with a memory 804, such as electronic random access memory (RAM), or other forms of transitory or non-transitory computer readable storage mediums, operating under control of or in conjunction with an operating system 808. The operating system 808 can be any commercial, open-source, or proprietary operating system or platform. The processor 802 can communicate with a database 812, such as a database stored on a local hard drive. While illustrated as a local database in the server 800, the database 812 can be separate from the server 800.

The processor 802 can further communicate with a communication module 806, such as a wired or wireless data connection, which in turn communicates with the wide area network 834. In particular, the communication module 806 can comprise a WWAN transceiver 816 capable of communicating with the wide area network 834. The set of ports 820, 822 of the server 800 can use the components of the communication module 806 to connect to the entities of the environment 100. For example, the input port 820 can receive parameter data via the WWAN transceiver 816, and the output port 822 can stream audio data via the WWAN transceiver 816. The processor 802 can also communicate with a set of applications 810 that can be configured to execute control logic and perform data processing to perform the functions and techniques as discussed herein. For example, the set of applications 810 can comprise a music service 807 that can support the functionalities of the music service, such as the playlist generation functionalities, as described herein. It should be appreciated that other applications 810 and functionalities thereof are envisioned.

While FIG. 8 illustrates the server 800 as a standalone system using a combination of hardware and software, the components of the server 800 can also be implemented as a software application or program capable of being executed by a conventional computer platform. Likewise, the components of the server 800 can also be implemented as a software module or program module capable of being incorporated in other software applications and programs. In either case, the components of the server 800 can be implemented in any type of conventional proprietary or open-source computer language.

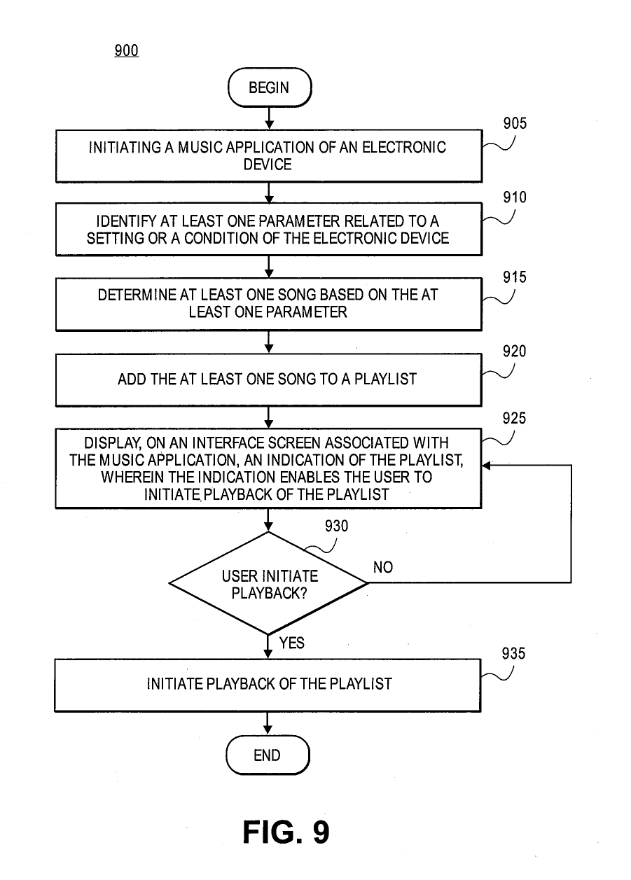

FIG. 9 is a flowchart of a method 900 for an electronic device (such as the device 105) to generate a playlist based on device parameters. It should be appreciated that the functionalities of the method 900 can be implemented with the electronic device executing an application and interfacing with a remote server, such as the music service server 115. The method begins when the electronic device initiates 905 a music application or service of the electronic device. In embodiments, a user can request for the electronic device to initiate the music application, for example by selecting an icon associated with the music application.

The electronic devices identifies 910 at least one parameter related to a setting or a condition of the electronic device. For example, the at least one parameter can be a date, time, location, weather condition, scheduled item, and/or other parameters, as discussed herein. The electronic device determines 915 at least one song based on the at least parameter. Particularly, the electronic device can communicate or otherwise interface with the remote server to identify the at least one song based on the at least one parameter matching various attributes of the at least one song. The electronic device adds 920 the at least one song to a playlist. In embodiments, the playlist can be empty or can include songs that the electronic device previously added.

The electronic device displays 925, on an interface screen associated with the music application, an indication of the playlist, wherein the indication enables the user to initiate playback of the playlist. In embodiments, the indication can include metadata associated with one or more songs of the playlist, such as album artwork, song titles, artist names, and/or other information. The electronic device determines 930 if the user has initiated playback of the playlist. If the user has not initiated playback “NO”, processing can return to 925. In contrast, if the user has initiated playback “YES”, the electronic device initiates 935 playback of the playlist. In embodiments, the playback can be according to an order in which the electronic device added the songs of the playlist or can be in a random order.

Thus, it should be clear from the preceding disclosure that the systems and methods offer improved playback generation techniques. The systems and methods advantageously provide music to users, wherein the music is identified based on various settings or conditions associated with the user and/or the user's electronic device. Additionally, the systems and methods advantageously enable the users to initiate playback of the music in response to initiating a corresponding music service application.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. A method of automatically generating playlists for a user of an electronic device, the method comprising:
initiating a music application of the electronic device;
responsive to the initiating, identifying, using a processor, at least one parameter related to a setting or a condition of the electronic device;
responsive to the identifying, determining, by the processor, at least one song based on the at least one parameter;
adding the at least one song to a playlist; and
displaying, on an interface associated with the music application, an indication of the playlist, wherein the indication of the playlist enables the user to initiate playback of the playlist.

2. The method of claim 1, wherein the at least one parameter comprises at least one of a time, a location, a weather condition, a date, or a day of week.

3. The method of claim 1, further comprising:
generating a title of the playlist based on the at least one parameter; and
displaying the title of the playlist on the interface.

4. The method of claim 1, wherein determining the at least one song based on the at least one parameter comprises:
sending the at least one parameter to a server, wherein the server identifies the at least one song by comparing an attribute of the at least one song to the at least one parameter; and
receiving an indication of the at least one song from the server.

5. The method of claim 1, further comprising:
receiving a selection by the user of the indication of the playlist; and
in response to receiving the selection, initiating playback of the playlist.

6. The method of claim 5, wherein initiating playback of the playlist comprises:
requesting a server to provide the at least one song of the playlist; and
receiving, from the server, audio data corresponding to the at least one song; and
outputting, via an audio component of the electronic device, the at least one song according to the audio data.

7. The method of claim 1, wherein the at least one song is further determined based on a music profile of the user.

8. The method of claim 1, wherein identifying the at least one parameter related to the setting or the condition of the electronic device comprises:
interfacing with an additional application of the electronic device to identify an appointment or an activity of the user, wherein the at least one parameter is based on the appointment or the activity.

9. The method of claim 1, wherein identifying the at least one parameter related to the setting or the condition of the electronic device comprises:
identifying a location of the electronic device; and
determining the at least one parameter based on the location of the electronic device.

10. The method of claim 1, wherein adding the at least one song to the playlist comprises adding metadata associated with the at least one song to the playlist.

11. An electronic device capable of generating playlists for a user, the electronic device comprising:
an interface capable of receiving inputs from the user and presenting information to the user; and
a processor coupled to the user interface and configured to perform operations comprising:
initiating a music application,
responsive to the initiating, identifying at least one parameter related to a setting or a condition of the electronic device,
responsive to the identifying, determining at least one song based on the at least one parameter,
adding the at least one song to a playlist, and
displaying, on the interface, an indication of the playlist, wherein the indication of the playlist enables the user to initiate playback of the playlist.

12. The electronic device of claim 11, wherein the at least one parameter comprises at least one of a time, a location, a weather condition, a date, or a day of week.

13. The electronic device of claim 11, wherein the processor is configured to perform operations further comprising:
generating a title of the playlist based on the at least one parameter, and
displaying the title of the playlist on the interface.

14. The electronic device of claim 11, further comprising a communication module, wherein determining the at least one song based on the at least one parameter comprises:
sending the at least one parameter to a server via the communication module, wherein the server identifies the at least one song by comparing an attribute of the at least one song to the at least one parameter, and
receiving an indication of the at least one song from the server via the communication module.

15. The electronic device of claim 11, wherein the processor is configured to perform operations further comprising:
receiving a selection by the user of the indication of the playlist, and
in response to receiving the selection, initiating playback of the playlist.

16. The electronic device of claim 15, further comprising an audio component, wherein initiating playback of the playlist comprises:
requesting a server to provide the at least one song of the playlist, and
receiving, from the server, audio data corresponding to the at least one song, and
outputting, via the audio component, the at least one song according to the audio data.

17. The electronic device of claim 11, wherein the at least one song is further determined based on a music profile of the user.

18. The electronic device of claim 11, wherein identifying the at least one parameter related to the setting or the condition of the electronic device comprises:
interfacing with an additional application to identify an appointment or an activity of the user, wherein the at least one parameter is based on the appointment or the activity.

19. The electronic device of claim 11, wherein identifying the at least one parameter related to the setting or the condition of the electronic device comprises:
identifying a location of the electronic device, and
determining the at least one parameter based on the location of the electronic device.

20. The electronic device of claim 11, wherein adding the at least one song to the playlist comprises adding metadata associated with the at least one song to the playlist.
